(19) United States
(12) Patent Application Publication
(10) Pub. No.: US 2026/0291664 A1
(43) Pub. Date: Sep. 24, 2026

(54) GENERATING ORTHOGONAL TIME FREQUENCY DIVISION MULTIPLEXING (OTFDM) WAVEFORMS WITH CIRCULAR DELAY DIVERSITY IN FREQUENCY DOMAIN

(71) Applicant: WISIG NETWORKS PRIVATE LIMITED, Madinaguda, Hyderabad (IN)

(72) Inventors: Koteswara Rao Gudimitla, Srikalahasti (IN); Sibgath Ali Khan Makandar, Hyderabad (IN)

(21) Appl. No.: 19/475,158

(22) PCT Filed: May 11, 2024
(86) PCT No.: PCT/IN2024/050521

§ 371 Date: Oct. 14, 2025

(30) Foreign Application Priority Data
May 11, 2023 (IN) 202341033327
Jun. 9, 2023 (IN) 202341039732

(51) Int. Cl. H04L 5/00

(52) U.S. Cl. CPC H04L 5/0026; H04L 5/0094

(57) ABSTRACT

Embodiments of the present disclosure are related to method of generating orthogonal time frequency division multiplexing (OTFDM) waveforms. The method comprising generating, by a communication system, at least one data sequence and at least one reference sequence (RS). Also, the method comprising time-multiplexing the at least one data sequence with the at least one RS, to generate a multiplexed sequence, and transforming the multiplexed sequence using a DFT to generate a transformed sequence. Further, the method comprising obtaining precoded sequences from the transformed sequence, by applying a distinct frequency domain phase rotation vector on the transformed sequence. Furthermore, mapping each precoded sequence to a corresponding antenna port of the communication system to obtain a plurality of mapped sequences. Thereafter, generating OTFDM waveform corresponding to each antenna port using the associated mapped sequence.

### CROSS-REFERENCE TO RELATED APPLICATIONS

This application claims priority from the Indian Provisional Patent Application Numbers i) 202341033327 filed on May 11, 2023 and ii) 202341039732 filed on Jun. 9, 2023, the entirety of which are hereby incorporated by reference.

### TECHNICAL FIELD

Embodiments of the present disclosure are related, in general to communication, but exclusively relate to methods for generating and transmitting orthogonal time frequency division multiplexing (OTFDM) waveform with circular delay diversity in frequency domain.

### BACKGROUND

Orthogonal Frequency Division Multiplexing (OFDM) is widely used in telecommunication and Wireless Fidelity (Wi-Fi) systems. OFDM allows resourceful utilization of a bandwidth. OFDM involves creating sub-carriers from a wideband carrier. Each sub-carrier is an orthogonal frequency, and each sub-carrier carriers a sequence of data. The procedure of mapping data sequence to sub-carriers is known as sub-carrier mapping. The use of orthogonal frequencies helps in reducing guard bands, thus utilizing the bandwidth completely. Because of these advantages, OFDM has been used as a basic waveform for downlink in LTE, LTE advanced, and 5G-NR. However, OFDM use multiple sub-carriers, using OFDM for uplink leads to high Peak Power to Average Ratio (PAPR).

Higher the PAPR of the transmitter signal, higher will be the power backoff of the Power Amplifier (PA), which results in low power transmissions of Uplink signal. Hence, the cell range/radius will be compromised. Addressing the PAPR issue in OFDM, Discrete Fourier Transform (DFT) spread OFDM (DFT-s-OFDM) has been proposed and eventually used for transmitting data. Here, the data is first precoded by taking a DFT of allocation size before mapping the data to the allocated sub-carriers. The DFT-s-OFDM is essentially a single carrier modulation scheme. Hence, DFT-s-OFDM has lower PAPR compared to OFDM. Furthermore, DFT-s-OFDM has similar robustness to the frequency selective fading as OFDM as cyclic prefix is introduced to reduce Inter Symbol Interference (ISI).

To further reduce the PAPR of DFT-s-OFDM waveform, waveform-based solutions like Pi/2-BPSK modulation is used to modulate the user data. On the DFT precoded pi/2-BPSK symbols spectrum shaping filter is applied to reduce the PAPR further. Low PAPR allows the signal to be transmitted at higher transmitting power by reducing the PA power backoff. However, spectrum shaping along with DFT precoding may not show much effect on the PAPR of higher modulation schemes resulting in no improvement in increasing the transmit signal power.

In existing systems, a DFT-s-OFDM symbol comprises a data sequence or a pilot sequence (reference sequence). The reference sequence is necessary for enabling channel equalization. The data sequence and the reference sequence are time multiplexed and are sent as independent symbols, i.e., in one symbol data sequence is transmitted and, in another symbol, the reference sequence is transmitted. Hence, in every symbol reference signal may be present. However, in mm wave systems there is a need to track the phase variation caused by Oscillator drift within/on each OFDM symbol. When uplink transmitter employs DFT-S-OFDM there is need for a provision to enable phase tracking within one OFDM symbol or across OFDM symbols.

In systems like URLLC, which is one of the use cases in current 5G systems, requires very low latency communications. In current systems, data and reference signals are transmitted in different symbols. The channel is estimated on the reference signal, which eventually will be used for demodulation of the received user data. Hence, latency may be present because of transmission of reference signal and data in different symbols. Also, in systems where the user moves at high velocities such as in high-speed trains/satellites the propagation channel varies fast in time causing rapid variations in magnitude/phase of the channels. In such cases there needs to be a mechanism to enable channel magnitude/phase tracking. The waveform should also be constructed such that the overall signal has low peak-to-average ratio (PAPR) and enables operation of the power amplifier (PA) efficiency with low back-off.

3GPP (3rd Generation Partnership Project) has developed 5G-NR standards to support use cases like eMBB, URLLC, MMTC. It has been agreed to use CP-OFDM waveform and DFT-s-OFDM waveform for uplink transmission in 5G-NR. Here, CP-OFDM is mainly used for higher data rates, while, because of its low PAPR and high-power efficiency, DFT-s-OFDM is used to serve the cell edge UEs. Current 5G standards uses slot structure, where user data is transmitted in series of OFDM symbols. A typical slot structure comprises of one or more data symbols and one or more reference symbols.

6G Mobile Communication System requires a method of information transmission and that offers extremely low latency, very high data rate, and very high-power efficiency. DFT-S-OFDM waveform, which is power efficient and supports high data rates is well suitable for this purpose. However, to achieve extremely low latency, it is desirable to transmit the information (like user data, RS, and control information) in a single shot i.e., using a single OFDM symbol. However, conventional DFT-S-OFDM requires at least one data symbol and at least one reference symbol (RS). The RS is required for the purpose of estimating the channel state information (CSI) and subsequent equalization of data symbol. The current two-symbol structure in 5G-NR not only doubles the latency (compared to single symbol case), but also has a higher RS overhead i.e., 50%. There is a need for a new type of waveform that allows at least one-shot transmission with flexible RS overhead and high-power efficiency. Furthermore, transmission of control information requires appropriate spreading methods of control/data/RS for at least one-shot transmission waveform with high-power efficiency.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for transmitting a plurality of OTFDM waveforms with circular transmit diversity is disclosed. The method comprising generating, by a communication system, at least one data sequence and at least one reference sequence (RS). Also, the method comprising time-multiplexing the at least one data sequence with the at least one RS, to generate a multiplexed sequence, and transforming the multiplexed sequence using a Discrete Fourier Transform (DFT) to generate a transformed sequence. Further, the method comprising obtaining a plurality of precoded sequences from the transformed sequence, wherein each of the plurality of precoded sequences is generated by applying a distinct frequency domain phase rotation vector on the transformed sequence. Furthermore, the method comprising mapping, by the communication system, each of the plurality of precoded sequences to a corresponding antenna port of the communication system to obtain a plurality of mapped sequences. Thereafter, the method comprises generating an OTFDM waveform corresponding to each antenna port using the associated mapped sequence, wherein each of antenna port specific OTFDM waveform is transmitted using the corresponding antenna port.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIGS. 1A and 1B shows orthogonal time frequency division multiplexing (OTFDM) symbol structures with data and RS;

FIGS. 1C-1D shows an illustration of pre-DFT symbols or multiplexed symbols, in accordance with another embodiment of the present disclosure;

FIG. 1E shows an illustration of a pre-DFT or multiplexed symbol with data RS CP, RS, data CP, and data;

FIG. 2A shows a communication system for generating an orthogonal time frequency division multiplexing (OTFDM) waveform with circular delay diversity in frequency domain, in accordance with an embodiment of the present disclosure;

FIG. 2B shows a block of orthogonal time frequency division multiplexing (OTFDM) symbol generation unit, in accordance with an embodiment of the present disclosure;

FIG. 2C shows a block diagram illustration of the processing unit of the OTFDM symbol generation unit, in accordance with another embodiment of the present disclosure;

FIG. 2D shows a block diagram illustration of the processing unit of the OTFDM symbol generation unit, in accordance with another embodiment of the present disclosure;

FIG. 3 shows a block of a communication system for generating and transmitting a plurality of orthogonal time frequency division multiplexing (OTFDM) waveforms, in accordance with some embodiments of the present disclosure;

FIG. 4 shows a block of a communication system for generating OTFDM waveforms with circular delay diversity in frequency domain, in an embodiment of the present disclosure;

FIGS. 5A-5C show examples illustrating generation of a plurality of precoded sequences from a transformed sequence for transmission on the associated antennas, in accordance with an embodiment of the present disclosure;

FIGS. 6A-6B shows an illustration of Orthogonal Time Frequency Division Multiplexing (OTFDM) symbol structures with data and RS;

FIG. 7A shows a block of a communication system for generating OTFDM waveform with circular delay diversity using STBC, in accordance with an embodiment of the present disclosure;

FIG. 7B shows a block diagram of an OTFDM symbol generation unit 700, in accordance with some embodiments of the present disclosure; and

FIG. 8 shows a block diagram of receiver, in accordance with an embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

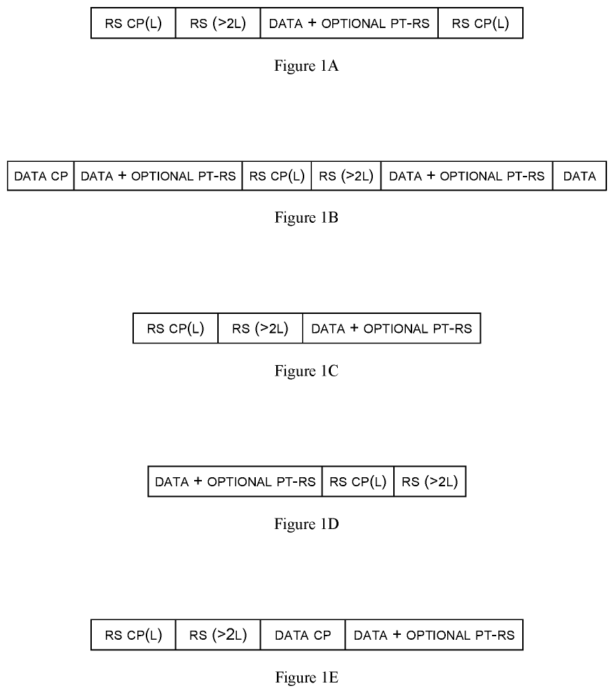

Embodiments of the present disclosure relate to generate at least an orthogonal time frequency division multiplexing (OTFDM) waveform using at least one of an input pre-DFT/multiplexed symbol. The at least one pre-DFT/multiplexed symbol is DFT precoded and applied with antenna specific weights to generate one or more precoded sequences. The present disclosure a method for generating a waveform is disclosed. The method comprising generating at least one data sequence or at least one reference sequence (RS). Also, the method comprises time-multiplexing the data sequence with the RS to generate a multiplexed sequence. The time multiplexed sequence is referred as a pre-DFT symbol. The multiplexed sequence also includes at least one of RS cyclic prefix (CP), RS cyclic suffix/post fix (CS), data CP and optional phase tracking reference signal (PT-RS). The multiplexed sequence is as shown in FIGS. 1A and 1B.

FIGS. 1A and 1B shows orthogonal time frequency division multiplexing (OTFDM) symbol structures with data and RS. FIG. 1A shows an illustration of a symbol with RS pre-fix, RS, RS post-fix and data. FIG. 1B shows an illustration of a symbol with data CP, data, RS pre-fix, RS, and data. The one OTFDM symbol length is M, comprising of data and RS. In an embodiment, the data may optionally include PT-RS for phase compensation at the receiver.

FIGS. 1C-1D shows an illustration of pre-DFT symbols or multiplexed symbols, in accordance with another embodiment of the present disclosure. FIG. 1E shows an illustration of a pre-DFT or multiplexed symbol with data RS CP, RS, data CP, and data.

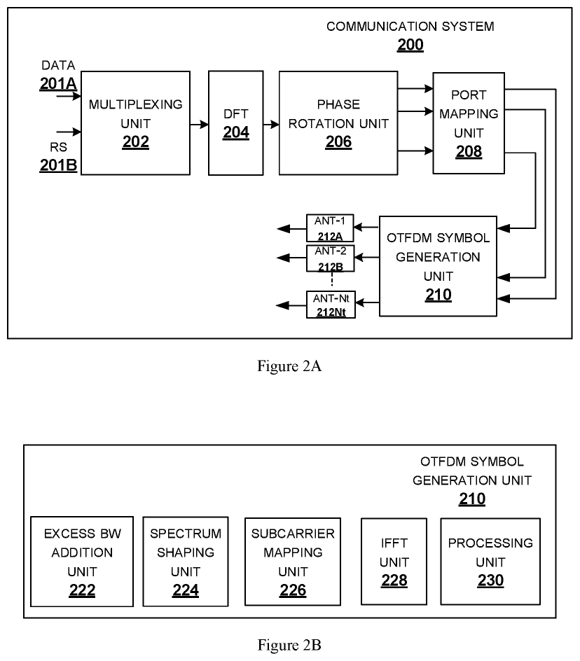

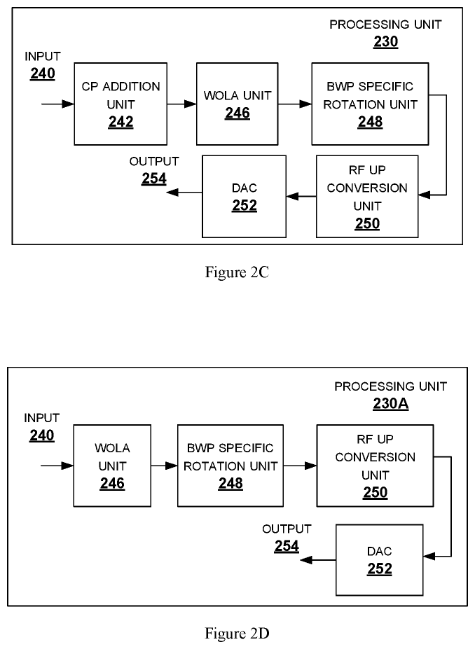

FIG. 2A shows a communication system for generating an orthogonal time frequency division multiplexing (OTFDM) waveform with circular delay diversity in frequency domain, in accordance with an embodiment of the present disclosure. The communication system is referred to as a transmitter or OTFDM transmitter or a base station (BS). In an embodiment, the communication system is a user equipment (UE).

As shown in FIG. 2A, the communication system comprises a multiplexing unit 202, a Discrete Fourier Transform (DFT) unit 204, a phase rotation unit 206, a port mapping unit 208, an OTFDM symbol generation unit 210, and a plurality of antennas (212A, 212B, . . . , 212Nt). The multiplexing unit 202 is also referred as time multiplexing unit or pre-DFT multiplexing unit. The DFT unit 204 is also referred to as transform unit. The phase rotation unit 206 is also referred as a frequency domain phase rotation unit or phase rotator or frequency domain rotation unit or precoder. The plurality of antennas (212A, 212B, . . . 212Nt) together is represented using 212 or referred to as antennas 212.

The communication system comprises a pre-DFT generator or inputs generator to generate at least one data 201A and at least one RS 201B. The at least one data is also referred as at least one data sequence or data. In an embodiment, the RS 201B is also referred as RS.

The at least one data sequence is one of a pi/2 binary phase shift keying (pi/2-BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence. The at least one data sequence comprises at least one of a user data, a control information, system information, and paging messages. In an embodiment, the user data, control information, system information, and paging messages is a modulated alphabet or sequences of modulated alphabets. The at least one data sequence is appended with a data cyclic prefix (CP), in an embodiment as shown in FIG. 1B. Also, the at least one data sequence may comprise a user data and at least one phase tracking reference sequence (PTRS).

In an embodiment, a spreading operation is performed on the at least one data sequence with a spread code to generate a spread data sequence. The spread data sequence is multiplexed with the at least one RS, in an embodiment of the present disclosure.

The at least one RS is one of a pi/2 binary phase shift keying (pi/2-BPSK) sequence, a BPSK sequence, a Zadoff-Chu (ZC) sequence, a Quadrature Phase Shift Keying (QPSK) sequence, and a M-ary Phase Shift Keying (PSK) sequence. In an embodiment, the at least one RS is appended with at least one of a cyclic prefix (CP) and a cyclic suffix (CS). As shown in FIG. 1A, the RS is prefixed and post-fixed using a CP or RS CP.

The multiplexing unit 202 performs multiplexing of the at least one data sequence 201A and the at least one RS 201B to generate a multiplexed sequence. The multiplexed sequence is one of the sequences or symbols as shown in the FIGS. 1A-1E. The multiplexed sequence is also referred to as a pre-DFT symbol or pre-DFT sequence.

In an embodiment, a spreading operation is performed on the multiplexed sequences with a corresponding spread code to generate a spread multiplexed sequences. Thereafter, the spread multiplexed sequences are transformed using the DFT unit 204

The DFT unit 204 transforms the multiplexed sequence, generated by the multiplexing unit 202, using a Discrete Fourier Transform (DFT) to generate a transformed multiplexed sequence.

The phase rotation unit 206 applies a distinct frequency domain phase rotation vector on the transformed sequence to obtain a plurality of precoded sequences. In an embodiment, the number of times the phase rotation vector is applied on the transformed multiplexed sequence is same as the number of antennas (Nt). Each of the frequency domain phase rotation vector is distinct and is generated using a complex exponential sequence with antenna port specific phasor sequence.

In an embodiment, the frequency domain phase rotation vector is a phase ramp sequence. The phase ramp sequence vector's phase varies across a plurality of subcarriers, the phase ramp sequence is generated using an antenna specific cyclic shift index.

The frequency domain phase rotation vector is a phase ramp sequence in an embodiment. The phase ramp sequence's phase is constant within a physical resource group (PRG) and varies across other PRGs, wherein the phase ramp sequence is generated using an antenna specific cyclic shift index. Each of the PRGs comprises a predefined number of subcarriers, said predefined number is an integer. In an embodiment, the predefined number is 6 or multiples of 6.

In an embodiment, the frequency domain phase rotation vector is a predetermined precoder. The phase and amplitude of the predetermined precoder varies across at least one of subcarriers and PRGs. Also, the frequency domain phase rotation vector for a specific antenna port is same for a predetermine time period or predetermine number of time units. The predetermined umber of time units is referred to as radio frames.

In an embodiment, the frequency domain phase rotation vector is indicated by a receiver to the communication system. For example, if the communication system is a base station, then the receiver is a user equipment (UE). Here the UE provides a feedback of W i.e. frequency domain phase rotation vector to the base station which will be applied by the base station on the transmit data corresponding to that particular UE to generate a plurality of precoded sequences, which is referred as closed loop precoding. In another embodiment, the receiver may feedback the index of the frequency domain phase rotation vectors that are defined a priory at the transmitter and receiver. In an embodiment, the frequency domain phase rotation vectors are obtained from the DFT weights.

In another embodiment of the present disclosure, the communication system may apply a frequency domain phase rotation vector on the transmit data without any feedback from the receiver (UE). The frequency domain phase rotation vectors may be obtained from a set of predefined vectors. The predefined vector may be obtained from DFT weights.

The port mapping unit 208 is also referred to as antenna port mapping unit or antenna port mapper or mapping unit. The mapping unit 208 performs port mapping of each of the plurality of precoded sequences to a corresponding antenna port of the communication system to obtain a plurality of mapped sequences.

The OTFDM symbol generation unit 210 generates an OTFDM waveform corresponding to each antenna port using the associated mapped sequence. Each plurality of mapped sequences is fed to the OTFDM symbol generation unit 210 to generate a plurality of OTFDM waveforms specific to a particular antenna. Each of antenna port specific OTFDM waveform is transmitted using the corresponding antenna port. The communication unit achieves a circular delay diversity by transmitting the plurality of OTFDM waveforms from a plurality of antenna ports with different phase rotations.

FIG. 2B shows a block of orthogonal time frequency division multiplexing (OTFDM) symbol generation unit, in accordance with an embodiment of the present disclosure. The OTFDM symbol generation unit 210 is also referred to as OTFDM generation unit 210 or an excess bandwidth (BW) DFT-s-OFDM symbol generation unit or OTFDM generator. As shown in FIG. 2B, the OTFDM symbol generation unit 210 comprises an excess BW addition unit 222, a spectrum shaping unit 224, a sub-carrier mapping unit 226, an inverse Fast Fourier transform (IFFT) unit 228 and a processing unit 230.

The excess BW extension unit 222 performs padding operation by prefixing each of the plurality of mapped sequences with a first predefined number (N1) of subcarriers and post-fixing the transformed multiplexed sequence with a second predefined number (N2) of subcarriers to obtain corresponding plurality of extended bandwidth mapped sequences. The value of the N1 is at least zero, and value of the N2 is at least zero. The values of N1 and N2 may be same or different. The value of N1 and N2 may depend on the excess power that is sent by the transmitter.

The spectrum shaping unit 224, also referred as a shaping unit or a filter, performs shaping of the plurality of extended bandwidth mapped sequences to obtain a plurality of shaped sequences or shaped sequences. The filter used for the shaping operation on the extended bandwidth transformed multiplexed sequence is one of a Nyquist filter, square root raised cosine filter, a raised cosine filter, a hamming filter, a Hanning filter, a Kaiser filter, an oversampled GMSK filter and any filter that satisfies predefined spectrum characteristics.

The sub carrier mapping unit 226, also referred as a mapper or a sub carrier mapper or a mapping unit, performs subcarrier mapping on the shaped extended bandwidth transformed multiplexed sequence or shaped sequence with at least one of localized and distributed subcarriers to generate a plurality of mapped sequences. In an embodiment, the distributed subcarrier mapping includes insertion of zeros in to the extended bandwidth transformed multiplexed sequence.

The Inverse Fast Fourier Transform (IFFT) unit 228 performing IFFT on each of the plurality of shaped sequences to produce a plurality of time domain sequences.

The processing unit 230 processes the plurality of time domain sequences to generate a plurality of OTFDM waveforms, also referred to as a filtered-extended bandwidth DFT-s-OFDM waveform.

FIG. 2C shows a block diagram illustration of the processing unit of the OTFDM symbol generation unit, in accordance with another embodiment of the present disclosure. As shown in the FIG. 2C, the processing unit 230 comprises a cyclic prefix (CP) addition unit 242, a weighted with overlap and add operation (WOLA) unit 246, bandwidth parts (BWP) rotation unit 248, a radio frequency (RF) conversion unit 250 and a digital to analog converter (DAC) 252.

The processing unit 230 processes an input 240 i.e. the plurality of time domain sequences to generate a plurality of OTFDM waveforms or also referred to as output 254. The processing unit 230 processes each of the plurality of time domain sequences by performing at least one of a symbol specific phase compensation, an addition of symbol cyclic prefix or addition of symbol cyclic suffix using the CP addition unit 242, windowing or weighted with overlap and add operation (WOLA) operation using the WOLA unit 246, a BWP rotation using the BWP rotation unit 248, an additional time domain filtering, sampling rate conversion using RF up conversion unit 250 to match DAC rate, frequency shifting on the time domain waveform and digital to analog conversion using DAC 252, to generate an OTFDM waveform. The OTFDM symbol generation unit generates a plurality of OTFDM waveforms corresponding to the plurality of time domain sequences. Thereafter, the communication system transmits an OTFDM waveform by mapping the generated OTFDM symbols to the corresponding antenna ports of the communication system. The generated OTFDM waveform which eventually offers low PAPR.

FIG. 2D shows a block diagram illustration of the processing unit of the OTFDM symbol generation unit, in accordance with another embodiment of the present disclosure. As shown in the FIG. 2D, the processing unit 230A comprises a weighted with overlap and add operation (WOLA) unit 246, bandwidth parts (BWP) rotation unit 248, a radio frequency (RF) conversion unit 250 and a digital to analog converter (DAC) 252.

The processing unit 230A processes each of the plurality of time domain sequences, also referred to as an input, 240 to generate a plurality of OTFDM waveform 254. The time domain sequence is obtained for the IFFT unit, which is configured in the OTFDM symbol generation unit, in an embodiment. The input to OTFDM symbol generation is a plurality of time domain sequences as shown in FIGS. 1C-1D.

As shown in FIG. 2D, the processing unit processes each of the plurality of mapped sequences by performing at least one of a windowing or weighted with overlap and add operation (WOLA) operation using the WOLA unit 246, a BWP rotation using the BWP rotation unit 248, an additional time domain filtering, sampling rate conversion using RF up conversion unit 250 to match DAC rate, frequency shifting on the time domain waveform and digital to analog conversion using DAC 252, to generate the OTFDM waveform. The OTFDM symbol generation unit generates a plurality of OTFDM waveforms corresponding to the plurality of time domain sequences. Thereafter, the communication system transmits an OTFDM waveform by mapping the generated OTFDM symbols to the corresponding antenna ports of the communication system. The generated OTFDM waveform which eventually offers low PAPR. Also, the generating OTFDM waveforms have with circular delay diversity in frequency domain.

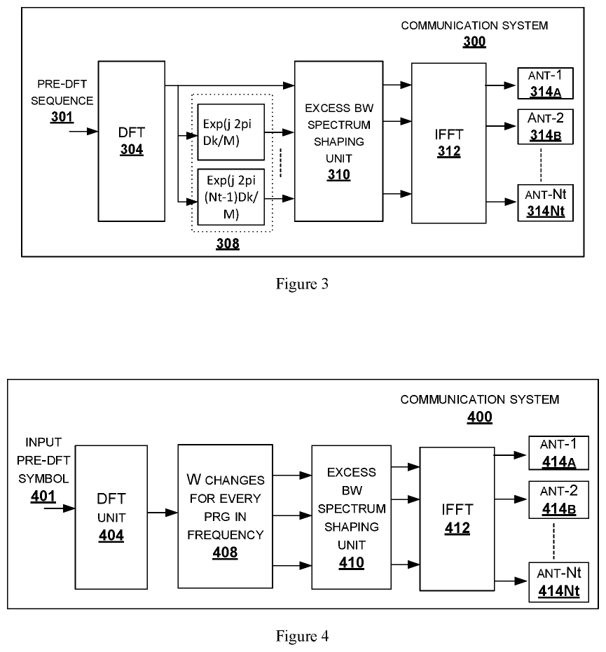

FIG. 3 shows a block of a communication system for generating and transmitting a plurality of orthogonal time frequency division multiplexing (OTFDM) waveforms, in accordance with some embodiments of the present disclosure. The communication system 300 is referred to as a transmitter or OTFDM transmitter or a base station (BS). In an embodiment, the communication system is a user equipment (UE). The communication system 300 performs transmission of the OTFDM waveform with circular delay diversity in frequency domain.

As shown in the FIG. 3, the communication system 300 comprises a Discrete Fourier Transform (DFT) unit 304, a phase rotation unit 308, a spectrum shaping unit 310, an inverse Fast Fourier Transform (IFFT) unit 312, and a plurality of antennas (314A, 314B, . . . , 314Nt).

In an embodiment, the communication system 300 includes an input pre-DFT/multiplexed sequence generator also referred as input pre-DFT generation unit or input generator. The input generator generates at least one data sequence and at least one RS. The at least one data sequence is multiplexed with the at least one RS to generate input pre-DFT symbol to the communication system. The pre-DFT sequence or multiplexed sequence is transformed using the DFT unit to generate a transformed sequence, also referred to as transformed pre-DFT sequence or symbol. The at least one pre-DFT symbol is one of the multiplexed symbols shown in FIGS. 1A, 1B, 1C, 1D and 1E.

The transformed sequence is directly fed to the excess BW spectrum shaping unit, along with the precoded sequences of the transformed sequence using

$${e}^{\frac{j 2 π Dk}{M}} ,$$

where i value ranges from 1 to number of antennas. D is a variable which is a function of the plurality of antennas. Also, the D is antenna specific variable.

The transformed sequence is applied with a subcarrier specific weight

$${e}^{\frac{j 2 π iDk}{M}}$$

to obtain a precoded sequence, where i={0, 1, 2, . . . , Nₜ−1}. k={0, 1, 2, . . . } is the subcarrier index Nₜ is the number of transmit streams available, and D is an arbitrary circular shift. D can take a value 0. The transformed sequence is directly fed to the excess BW spectrum and shaping unit, along with the precoded sequence of the transformed sequence, also referred to as phase shifted symbols or plurality of precoded sequences. In an embodiment, a spectrum extension is performed on the shifted phase symbols using spectrum shaping unit 310, such that last d/2 samples of the phase shifted symbol are copied and placed at the beginning of the symbol as pre-fix and then the initial d/2 samples of the phase shifted symbol are copied and placed at the end of the symbol as post-fix, where d is the spectrum extension factor. The precoded sequences are mapped to antenna port to obtain plurality of mapped sequences.

The spectrum shaping unit 310, also referred as an excess BW spectrum shaping unit or shaping unit or a filter, performs shaping on the plurality of mapped sequences to generate a plurality of shaped excess BW transformed sequences or also referred to as shaped sequences. The excess BW spectrum shaping unit or the filter used for the shaping operation on the transformed sequences is one of a Nyquist filter, square root raised cosine filter, a raised cosine filter, a hamming filter, a Hanning filter, a Kaiser filter, an oversampled GMSK filter and any filter that satisfies predefined spectrum characteristics.

Thereafter, the IFFT unit 312 performs inverse FFT on the shaped sequences to generate a plurality of time domain sequences specific to the each of the corresponding plurality of antennas. Each of the symbol sequence is sent to one of the associated plurality of antennas (314A, 314B, . . . , 314Nt) based on the value variable D, for transmission.

FIG. 4 shows a block of a communication system for generating OTFDM waveforms with circular delay diversity in frequency domain, in an embodiment of the present disclosure. As shown in FIG. 4, the communication system 400 is also referred as a transmitter or a base station (BS). In an embodiment, the communication system is a user equipment (UE). The communication system as shown in FIG. 4, comprises an input generation unit or pre-DFT/multiplexed symbol generation unit, a DFT unit 404, a phase rotation unit with a variable W for each PRB unit 408, an excess BW spectrum shaping unit 410, an IFFT unit 412 and a plurality of antennas (414A, 414B, . . . , 414Nt).

The input pre-DFT generator, also referred as input pre-DFT generation unit or input generator, generates a plurality of pre-DFT symbols. The symbols are as shown in FIGS. 1A-1E. The input pre DFT symbol 401 is fed to the DFT unit 404 to generate transformed sequence. The phase rotation unit with a variable W for each PRB unit 408 performs phase rotation on the transformed sequence to generate one or more rotated sequences. The phase rotation depends on a variable W which is constant for each PRB unit, where W is a column vector with elements being phase rotations. W is fixed in time for several frames but changes every PRG, where in PRG is a group of subcarriers or Physical Resource Blocks (PRBs), the group can be 1, 2, 3, 4 or multiples of 6 subcarriers or multiples of PRBs, each resource block contains predefined set of subcarriers, for example multiples of 6.

The excess BW spectrum shaping unit 410, also referred as a shaping unit or a filter, performs shaping on the one or more rotated sequences to generate a plurality of shaped excess BW transformed sequences or also referred to as shaped sequences. The excess BW spectrum shaping unit or the filter used for the shaping operation on the transformed sequences is one of a Nyquist filter, square root raised cosine filter, a raised cosine filter, a hamming filter, a Hanning filter, a Kaiser filter, an oversampled GMSK filter and any filter that satisfies predefined spectrum characteristics.

Thereafter, the IFFT unit 412 performs inverse FFT on the shaped sequences to generate a plurality of time domain sequences specific to the each of the corresponding plurality of antennas. Each of the symbol sequence is sent to a corresponding antenna (414A, 414B, . . . , 414Nt) based on the value variable D, for transmission.

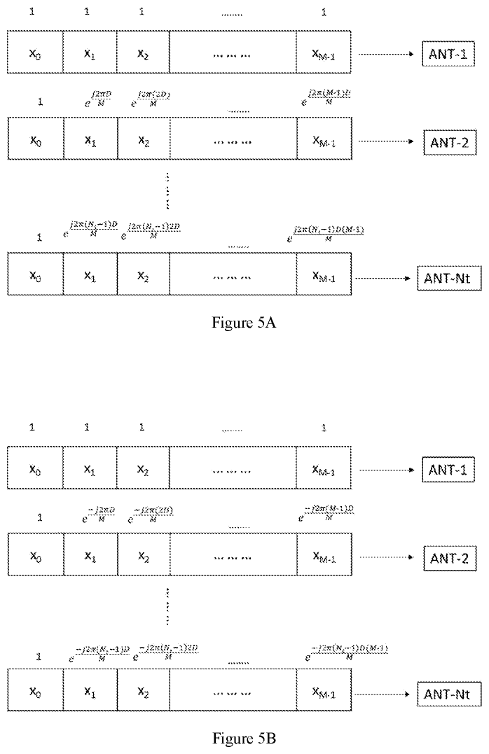

FIGS. 5A-5C show examples illustrating generation of a plurality of precoded sequences from a transformed sequence for transmission on the associated antennas, in accordance with an embodiment of the present disclosure.

FIG. 5A shows an illustration of generating a plurality of precoded sequences from the transformed sequence, each of the generated preceded sequence is associated with one of the Nt antennas. The antennas are also referred to as transmit antennas. As shown in FIG. 5A, there are Nt precoded sequences corresponding to Nt antennas. Each antenna is having a corresponding transformed sequence which is obtained by shifting the previous transformed sequence in frequency domain, for all the antennas i.e. each sample of the previous transformed sequence is multiplied with corresponding weights associated with the antenna.

For example, considering the base sequence or transformed sequence is [x₀, x₁, x₂ . . . x_{M-1}] which is associated with antenna-1 (ANT-1), then for antenna-2 (ANT-2) the precoded sequence is obtained by multiplying each element of the base sequence with the corresponding weights of

$$[ 1 , {e}^{- \frac{j 2 π D}{M}} , {e}^{- \frac{j 2 π 2 D}{M}} , {e}^{- \frac{j 2 π 3 D}{M}} , … {e}^{- \frac{j 2 π ( M - 1 ) D}{M}} ] .$$

For antenna-3 (ANT-3), the associated sequence-3 or precoded sequence-3 is obtained by multiplying each element of [x₀, x₁, x₂ . . . x_{M-1}] with the corresponding weights of

$$[ 1 , {e}^{\frac{j 2 π ( 2 D )}{M}} , {e}^{\frac{j 2 π 2 ( 2 D )}{M}} , {e}^{\frac{j 2 π 3 ( 2 D )}{M}} , … {e}^{\frac{j 2 π ( M - 1 ) ( 2 D )}{M}} ] .$$

Similarly, for the antenna-Nₜ (ANT-Nₜ), the associated sequence-Nₜ or precoded sequence-Nₜ is obtained by multiplying each element of [x₀, x₁, x₂ . . . x_{M-1}] with the corresponding weights of

$$[ 1 , {e}^{\frac{j 2 π ( N t - 1 ) D )}{M}} , {e}^{\frac{j 2 π 2 ( N t - 1 ) D}{M}} , {e}^{\frac{j 2 π 3 N t - 1 ) D}{M}} , … {e}^{\frac{j 2 π ( M - 1 ) ( N t - 1 ) D}{M}} ] .$$

FIG. 5B shows an illustration of generating a plurality of precoded sequences from the transformed sequence in accordance with another embodiment of the present disclosure, each of the generated preceded sequence is associated with one of the Nt antennas. As shown in FIG. 5B, there are Nt precoded sequences corresponding to Nt antennas which are obtained by circularly left shifting the base sequence in frequency domain.

In an embodiment, each sample of the transformed sequence is multiplied with a corresponding weights associated with the antenna.

For example, considering the base sequence or transformed sequence is [x₀, x₁, x₂ . . . x_{M-1}] which is associated with antenna-1 (ANT-1), then for antenna-2 (ANT-2) the precoded sequence is obtained by multiplying each element of the base sequence with the corresponding weights of

$$[ 1 , {e}^{- \frac{j 2 π D}{M}} , {e}^{- \frac{j 2 π 2 D}{M}} , {e}^{- \frac{j 2 π 3 D}{M}} , … {e}^{- \frac{j 2 π ( M - 1 ) D}{M}} ] .$$

For antenna-3 (ANT-3), the associated sequence-3 or precoded sequence-3 is obtained by multiplying each element of [x₀, x₁, x₂ . . . x_{M-1}] with the corresponding weights of

$$[ 1 , {e}^{- \frac{j 2 π ( 2 D )}{M}} , {e}^{- \frac{j 2 π 2 ( 2 D )}{M}} , {e}^{- \frac{j 2 π3 ( 2 D )}{M}} , … {e}^{- \frac{j 2 π ( M - 1 ) ( 2 D )}{M}} ] .$$

Similarly, for the antenna-Nₜ (ANT-Nₜ), the associated sequence-Nₜ or precoded sequence-Nₜ is obtained by multiplying each element of [x₀, x₁, x₂ . . . x_{M-1}] with the corresponding weights of

$$[ 1 , {e}^{- \frac{j 2 π ( N t - 1 ) D )}{M}} , {e}^{- \frac{j 2 π 2 ( N t - 1 ) D}{M}} , {e}^{- \frac{j 2 π 3 N t - 1 ) D}{M}} , … {e}^{- \frac{j 2 π ( M - 1 ) ( N t - 1 ) D}{M}} ] .$$

FIG. 5C shows an illustration of generating a plurality of precoded sequences from the transformed sequence, in accordance with yet another embodiment of the present disclosure. As shown in FIG. 5C, the transformed sequence is grouped into a plurality of groups, where each group comprises a set of samples/elements. In an embodiment each group is referred as a physical resource group (PRG). Each of the plurality of groups is applied with a corresponding weight associated with one of the plurality of antenna, for transmission. For example, for antenna-1 (ANT-1), the first group of precoded sequences is multiplied with

$${r}_{1} {e}^{\begin{matrix}j θ1 \\ \end{matrix}} ,$$

the second group is multiplied with

$${r}_{1} {e}^{\begin{matrix}j θ2 \\ \end{matrix}}$$

and this multiplication is performed till the last group, which is associated with the antenna-Nₜ.

When spectrum extension factor ‘d’ is zero, no spectrum extension is performed, for example modulation schemes like pi/2-BPSK. In this case, spectrum shaping can be performed either in time-domain by circular convolving the data-RS multiplexed symbol with impulse response of the spectrum shaping filter or in frequency domain, where the DFT-pre-coded symbol is simply multiplied with the frequency response of the spectrum shaping filter. The spectrum shaping help in reduction of PAPR, which eventually results in better power efficiency.

One embodiment of the present disclosure is a receiver. At the receiver, the received signal is first processed with front processing elements like ADC, CP removal and FFT. The allocated sub-carriers are de-mapped in the sub-carrier de-mapper, where M+d allocated sub-carriers are de-mapped from entire FFT output. If spectrum shaping performed at the transmitter is with square root of the frequency response of the spectrum shaping filter and filter is known at the receiver, then de-mapped “M+d” subcarriers are multiplied with the same filter used at the transmitter before further processing. This helps in maximizing the receiver SNR. If the filter is not known at the receiver, then the de-mapped data is processed without any receiver shaping. The filter used at the receiver can be called as subcarrier filters. Each of the subcarrier filters is one of SQRC, RC, Hanning, Hamming, Blackman, or LGMSK pulses, or square root of these pulses.

In an embodiment, the method includes a base sequence that is obtained by taking a BPSK sequence that goes through pi/2 constellation rotation. Various cyclic shifts of the base sequence may be used as inputs. The base sequences and the number of cyclic shifts that result in low PAPR and low correlation among the base sequences and zero correlation among the cyclic shifts of a base sequence may be obtained through a computer search. The base sequences are optimized such that the generated waveforms have optimized or low PARP.

In an embodiment of the present disclosure, a method for transmitting a plurality of OTFDM waveforms with circular transmit diversity is disclosed. The method comprising generating, by a communication system, at least one data sequence and at least one reference sequence (RS). Also, the method comprising time-multiplexing the at least one data sequence with the at least one RS, to generate a multiplexed sequence, and transforming the multiplexed sequence using a Discrete Fourier Transform (DFT) to generate a transformed sequence. Further, the method comprising obtaining a plurality of precoded sequences from the transformed sequence, wherein each of the plurality of precoded sequences is generated by applying a distinct frequency domain phase rotation vector on the transformed sequence. Furthermore, the method comprising mapping, by the communication system, each of the plurality of precoded sequences to a corresponding antenna port of the communication system to obtain a plurality of mapped sequences. Thereafter, the method comprises generating an OTFDM waveform corresponding to each antenna port using the associated mapped sequence, wherein each of antenna port specific OTFDM waveform is transmitted using the corresponding antenna port.

Embodiments of the present disclosure relates to a method for generating an Orthogonal Time Frequency Division Multiplexing (OTFDM) waveform using space time block coding (STBC). The OTFDM waveform enables 6G Mobile communication system a method of information transmission and that offers extremely low latency, very high data rate, and very high-power efficiency. OTFDM with STBC encoding provides transmission diversity in conditions where one antenna signal has low received power and other antenna higher power. The OTFDM-STBC receiver provides the diversity benefit.

In an embodiment of the present disclosure, the method of generating OTFDM waveform comprises generating at least one data sequence or at least one reference sequence (RS). Also, the method comprises time-multiplexing data sequences S1, S2 with a first RS (RS1) along with cyclic prefix (CP) of the first RS to generate a first multiplexed sequence. Also, time-multiplexing complex conjugate and time reversed data sequence with a negative symbol S2 i.e. −S2*, complex conjugate and time reversed data sequence S1* with a second RS (RS2) along with cyclic prefix (CP) of the second RS to generate a second multiplexed sequence. The first RS and second RS are orthogonal to each other. The data sequence (S1, S2) is a sequence of real/complex modulation alphabets.

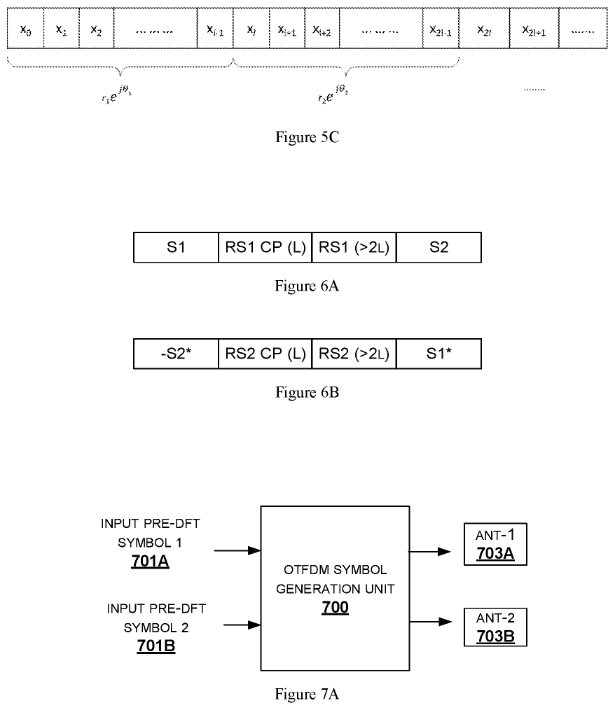

The first multiplexed sequence and second multiplexed sequence are collectively referred as multiplexed sequences or time multiplexed sequences. The multiplexed sequences are referred as a pre-DFT symbol. The first multiplexed sequence and second multiplexed sequence are as shown in FIGS. 6A and 6B respectively.

FIGS. 6A-6B shows an illustration of Orthogonal Time Frequency Division Multiplexing (OTFDM) symbol structures with data and RS. FIG. 6A shows an illustration of an OTFDM symbol with RS1 pre-fix, RS1, data S1 and data S2. FIG. 6B shows an illustration of an OTFDM symbol with RS2 pre-fix, RS2, complex conjugate-time reversed data with a negative symbol S2 i.e. −S2*, and complex conjugate-time reversed data S1. In an embodiment, the data sequence may optionally include PT-RS for phase compensation at the receiver.

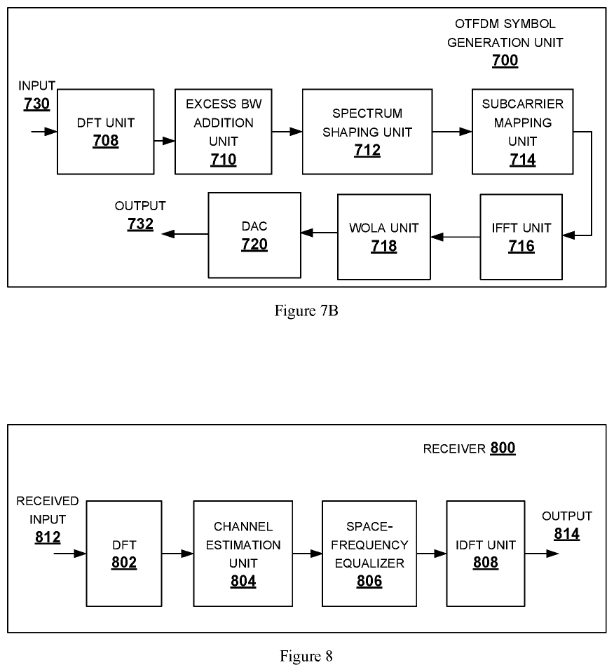

FIG. 7A shows a block of a communication system for generating OTFDM waveform with circular delay diversity using STBC, in accordance with an embodiment of the present disclosure. The communication system is also referred to as an OTFDM transmitter or transmitter or base station (BS). In an embodiment, the communication systems is a user equipment (UE). As shown in FIG. 7A, the transmitter comprises an OTFDM symbol generation unit 700, input pre-DFT generator, and a plurality of antennas. In an embodiment, the transmitter comprises two antennas (703A, 703B).

The input pre-DFT generator, also referred as input pre-DFT generation unit or input generator, generates one or more pre-DFT symbols or multiplexed symbols or symbols. The input to the transmitter are the symbols 701A, 701B as shown in FIGS. 6A-6B. Each of the symbols, also referred to as multiplexed sequences, are processed through the excess bandwidth (BW) symbol generation unit, to generate corresponding excess BW symbols or waveforms specific to a particular antenna. In an embodiment, the transmitter comprises two antennas. The waveforms generated are transmitted by the corresponding two antennas i.e. first waveform generated using the symbol of FIG. 6A is transmitted by ANT-1 703A and second waveform generated using the symbol of FIG. 6B is transmitted by ANT-2 703B.

FIG. 7B shows a block diagram of an OTFDM symbol generation unit 700, in accordance with some embodiments of the present disclosure. As shown in FIG. 7B, the OTFDM symbol generation unit 700, also referred to as an extended BW symbol generator, comprises a Discrete Fourier Transform (DFT) unit 708, an excess BW addition unit 710, a spectrum shaping unit 712, a subcarrier mapping unit 714, an IFFT unit 716, a WOLA unit 718, a DAC 720.

The DFT unit 708 transforms an input 730 i.e. a multiplexed sequence using a Discrete Fourier Transform (DFT) to generate a transformed multiplexed sequence. The input are the symbols as shown in FIGS. 6A and 6B. In an embodiment, each of the data sequences S1 and S2 as shown in FIGS. 6A and 6B, will includes a data cyclic prefix (CP). The symbols may include data CP are provided as input 730 to the OTFDM symbol generation unit 700, in an embodiment.

The excess BW extension unit 710 performs padding operation on the transformed multiplexed sequence i.e. prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero. The values of N1 and N2 may be same or different. The value of N1 and N2 may depend on the excess power that is sent by the transmitter.

The spectrum shaping unit 712, also referred as a with shaping unit with excess BW unit or excess BW unit shaping unit or shaper or a filter, performs shaping of the extended bandwidth transformed multiplexed sequence to obtain a shaped extended bandwidth transformed multiplexed sequence or shaped sequence. The filter used for the shaping operation on the extended bandwidth transformed multiplexed sequence is one of a Nyquist filter, square root raised cosine filter, a raised cosine filter, a hamming filter, a Hanning filter, a Kaiser filter, an oversampled GMSK filter and any filter that satisfies predefined spectrum characteristics.

The sub carrier mapping unit 714, also referred as a mapper or a sub carrier mapper or a mapping unit, performs subcarrier mapping on the shaped extended bandwidth transformed multiplexed sequence or shaped sequence with at least one of localized and distributed subcarriers to generate a mapped extended bandwidth transformed multiplexed sequence. In an embodiment, the distributed subcarrier mapping includes insertion of zeros in to the extended bandwidth transformed multiplexed sequence.

The IFFT unit 716 performing an Inverse Fast Fourier Transform (IFFT) on the shaped extended bandwidth transformed multiplexed sequence to produce a time domain sequence. Thereafter, the WOLA unit 718 performs weighted with overlap and add operation on the time domain sequence to produce windowed sequence. The DAC 720 generates an analog signal or waveform using the windowed sequence, the generated waveform is transmitted using one or more antennas, configured in the transmitter.

In an embodiment, the output of the IFFT unit 716 i.e. time domain sequence is padded with CP and processed though WOLA unit 718 and DAC 720 to generate waveform for transmission. The generated waveforms are transmitted using the two antennas, ANT-1 703A and ANT-2 703B.

In an embodiment, the transmitter 700 may comprise a processing unit after the subcarrier mapping unit 714. The processing unit processes the time domain sequence to generate the filtered-extended bandwidth DFT-s-OFDM symbol. The processing unit performs an Inverse Fast Fourier Transform (IFFT) on the shaped extended bandwidth transformed multiplexed sequence to produce a time domain sequence and processing the time domain sequence to generate the OTFDM symbol or filtered-extended bandwidth DFT-s-OFDM symbol. The processing of the time domain sequence to generate a OTFDM symbol comprises performing at least one of a symbol specific phase compensation, an addition of symbol cyclic prefix, addition of symbol cyclic suffix, windowing, weighted with overlap and add operation (WOLA), bandwidth parts (BWP) rotation, an additional time domain filtering, sampling rate conversion to match DAC rate, frequency shifting on the time domain waveform and a digital to analog converter (DAC), to generate an OTFDM waveform or filtered-extended bandwidth DFT-s-OFDM symbol for transmission.

FIG. 8 shows a block diagram of receiver, in accordance with an embodiment of the present disclosure. As shown in the FIG. 8, the receiver 800 comprises a Discrete Fourier Transform (DFT) unit 802, a channel estimation unit 804, a space frequency equalizer 806 and an inverse Discrete Fourier Transform (IDFT) unit 808. The channel estimation unit 804 is also referred to as a channel estimator or channel estimation unit on first RS and second RS.

The receiver receives an input referred as a received signal 812, which is first processed with front end processing unit comprising ADC and CP removal to produce processed received signal. In an embodiment, the DFT unit 802 is a fast Fourier transform (FFT). The DFT unit 802 transforms the processed signal from time domain to frequency domain to produce transformed sequence.

The transformed sequence is de-mapped using allocated sub-carriers using a sub-carrier de-mapper, where M+d allocated sub-carriers are de-mapped from entire FFT output. If spectrum shaping performed at the transmitter is with square root of the frequency response of the spectrum shaping filter and filter is known at the receiver, then de-mapped “M+d” subcarriers are multiplied with the same filter used at the transmitter before further processing. This helps in maximizing the receiver SNR. If the filter is not known at the receiver, then the de-mapped data is processed without any receiver shaping. The filter used at the receiver is referred as subcarrier filter. The subcarrier filter is one of SQRC, RC, Hanning, Hamming, Blackman, or LGMSK filters, or square root of these filters.

The channel estimation unit 804 estimates a channel from the de-mapped sequence based on an estimation method. The space frequency equalizer 806 performs equalization on the de-mapped sequence using the estimated channel to obtain an equalized sequence. Thereafter, the IDFT unit 808 performs an IDFT on the equalized sequence to generate a time domain sequence and de-multiplexing the time domain sequence to obtain an output 814 i.e. at least one of a reference sequence (RS) and a data sequence.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for transmitting a plurality of orthogonal time frequency division multiplexing (OTFDM) waveforms, comprising:
generating, by a communication system, at least one data sequence and at least one reference sequence (RS);
time-multiplexing, by a communication system, the at least one data sequence with the at least one RS, to generate a multiplexed sequence;
transforming, by the communication system, the multiplexed sequence using a Discrete Fourier Transform (DFT) to generate a transformed sequence;
obtaining, by the communication system, a plurality of precoded sequences from the transformed sequence, wherein each of the plurality of precoded sequences is generated by applying a distinct frequency domain phase rotation vector on the transformed sequence;
mapping, by the communication system, each of the plurality of precoded sequences to a corresponding antenna port of the communication system to obtain a plurality of mapped sequences; and
generating, by the communication system, an OTFDM waveform corresponding to each antenna port using the associated mapped sequence;
wherein each of antenna port specific OTFDM waveform is transmitted using the corresponding antenna port.

2. The method as claimed in claim 1, wherein the at least one data sequence is one of a pi/2 binary phase shift keying (pi/2-BPSK) sequence, a BPSK sequence, a Quadrature Phase Shift Keying (QPSK) sequence, M-ary Quadrature Amplitude Modulation (QAM) sequence, and an M-ary Phase Shift Keying (PSK) sequence.

3. The method as claimed in claim 1, wherein the at least one data sequence comprises at least one of a user data, a control information, system information, and paging messages, said user data, said control information, said system information, and said paging messages is a modulated alphabet or sequences of modulated alphabets.

4. The method as claimed in claim 1, wherein a spreading operation is performed on the at least one data sequence with a spread code to generate a spread data sequence.

5. The method as claimed in claim 1, wherein the at least one data sequence is appended with a data cyclic prefix (CP).

6. The method as claimed in claim 1, wherein the at least one data sequence comprises a user data and at least one phase tracking reference sequence (PTRS).

7. The method as claimed in claim 1, wherein the multiplexed sequence is appended with at least one of a corresponding CP and a corresponding CS.

8. The method as claimed in claim 1, wherein the at least one RS is one of a pi/2 binary phase shift keying (pi/2-BPSK) sequence, a BPSK sequence, a Zadoff-Chu (ZC) sequence, a Quadrature Phase Shift Keying (QPSK) sequence, and a M-ary Phase Shift Keying (PSK) sequence.

9. The method as claimed in claim 1, wherein the at least one RS is appended with at least one of a cyclic prefix (CP) and a cyclic suffix (CS).

10. The method as claimed in claim 1, wherein generating the plurality of OTFDM symbols comprising:
performing padding operation by prefixing each of the plurality of mapped sequences with a first predefined number (N1) of subcarriers and post-fixing each of the plurality of transformed sequences with a second predefined number (N2) of subcarriers to obtain corresponding plurality of extended bandwidth mapped sequences;
shaping each of the plurality of extended bandwidth mapped sequences using a filter to obtain a plurality of shaped sequences;
mapping each of the plurality of shaped sequences with at least one of localized and distributed subcarriers to generate a plurality of mapped sequences;
performing an Inverse Fast Fourier Transform (IFFT) on each of the plurality of shaped sequences to produce a plurality of time domain sequences; and
processing the plurality of time domain sequences to generate a plurality of OTFDM waveforms.

11. The method as claimed in claim 10, wherein value of the N1 is at least zero, and value of the N2 is at least zero.

12. The method as claimed in claim 10, wherein processing the plurality of time domain sequences to generate the plurality of OTFDM waveforms comprises performing at least one of addition of symbol cyclic prefix, addition of symbol cyclic suffix, windowing, weighted with overlap and add operation (WOLA), bandwidth parts (BWP) rotation, additional time domain filtering, sampling rate conversion to match DAC rate, frequency shifting and digital to analog conversion on the plurality of time domain sequences, to generate the plurality of OTFDM waveforms.

13. The method as claimed in claim 10, wherein the filter used for shaping each of the plurality of mapped sequences is one of a Nyquist filter, square root raised cosine filter, a raised cosine filter, a hamming filter, a Hanning filter, a Kaiser filter, an oversampled GMSK filter, a truncated version of Nyquist filter, a truncated version of square root raised cosine filter, a truncated version of raised cosine filter, a truncated version of hamming filter, a truncated version of Hanning filter, a truncated version of Kaiser filter, and a truncated version of an oversampled GMSK filter.

14. The method as claimed in claim 1, wherein each the frequency domain phase rotation vector is distinct and is generated using a complex exponential sequence with antenna port specific phasor value.

15. The method as claimed in claim 1, wherein the frequency domain phase rotation vector is a phase ramp sequence, wherein phase of the phase ramp sequence varies across a plurality of subcarriers, said phase ramp sequence is generated using an antenna specific cyclic shift index.

16. The method as claimed in claim 1, wherein the frequency domain phase rotation vector is a phase ramp sequence, said phase ramp sequence's phase is constant within a physical resource group (PRG) and varies across other PRGs, wherein the phase ramp sequence is generated using an antenna specific cyclic shift index.

17. The method as claimed in claim 16, wherein each PRG comprises is a predefined number of subcarriers, said predefined number is an integer.

18. The method as claimed in claim 1, wherein the frequency domain phase rotation vector is a predetermined precoder, wherein phase and amplitude of the predetermined precoder varies across at least one of subcarriers and PRGs.

19. The method as claimed in claim 1, wherein the frequency domain phase rotation vector for a specific antenna port is same for a predetermine number of time units or radio frames.

20. The method as claimed in claim 1, wherein the frequency domain phase rotation vector is indicated by a receiver to the communication system.
